(19) United States
(12) Patent Application Publication
(10) Pub. No.: US 2020/0228358 A1
(43) Pub. Date: Jul. 16, 2020

(54) COORDINATED INTELLIGENT MULTI-PARTY CONFERENCING

(71) Applicant: Calendar.com, Inc., Draper, UT (US)

(72) Inventor: John Rampton, Draper, UT (US)

(21) Appl. No.: 16/738,971

(22) Filed: Jan. 9, 2020

Related U.S. Application Data
(60) Provisional application No. 62/791,615, filed on Jan. 11, 2019.

(51) Int. Cl. H04L 12/18; G06Q 10/10; G10L 15/26; G06N 20/00

(52) U.S. Cl. CPC H04L 12/1831; H04L 12/1822; G06N 20/00; G10L 15/26; G06Q 10/1093

(57) ABSTRACT

Systems and methods are described for implementing a virtual assistant that manages and participates in events on an electronic calendar. The virtual assistant determines meeting times based on availability of key participants, and at the appropriate time logs the user into conference bridges, requests permission to record audio, records audio of the meeting, and uses a machine learning model to generate meeting transcripts that identify each participant and the associated portions of the audio recording during which the participant is speaking. The virtual assistant may summarize what was discussed at the meeting, and may associate the summary and transcript with the calendar event to provide a permanent record of the meeting. The virtual assistant may also selectively record only those participants who grant permission to be recorded, and may participate in the meeting and answer queries from meeting participants.

### CROSS-REFERENCE TO RELATED APPLICATION

This application claims the benefit of U.S. Provisional Application No. 62/791,615, entitled COORDINATED INTELLIGENT MULTI-PARTY CONFERENCING and filed Jan. 11, 2019, the entirety of which is hereby incorporated by reference herein.

### BACKGROUND

Generally described, computing devices can be used to manage an event calendar. Users of computing devices may send or receive invitations to calendar events, and may accept invitations to add events to their electronic calendars. Calendar events may include, for example, face-to-face meetings, conference calls, videoconferences, and other multi-party events or conferences. An electronic calendar may facilitate management of such events by, e.g., detecting and notifying the user of scheduling conflicts, identifying times at which potential meeting attendees are available, managing invitations, and the like.

An electronic calendar may thus provide a user with a schedule of events that the user is planning to attend or considering whether to attend. An electronic calendar may further provide the user with a record of past events, including details such as the times and places of past events, the parties who had accepted or rejected invitations to past events, and the like.

### SUMMARY

The systems, methods, and devices described herein each have several aspects, no single one of which is solely responsible for its desirable attributes. Without limiting the scope of this disclosure, several non-limiting features will now be discussed briefly.

Embodiments of the present disclosure relate to facilitating multi-party conferencing by implementing a virtual assistant that manages and participates in events on an electronic calendar. The virtual assistant determines meeting times based on availability of key participants, and at the appropriate time logs the user into conference bridges, requests permission to record audio, records audio of the meeting, and uses a machine learning model to generate meeting transcripts that identify each participant and the associated portions of the audio recording during which the participant is speaking. The virtual assistant may summarize what was discussed at the meeting, and may associate the summary and transcript with the calendar event to provide a permanent record of the meeting.

Additional embodiments of the disclosure are described below in reference to the appended claims, which may serve as an additional summary of the disclosure.

In various embodiments, computer systems are disclosed that comprise a data store configured to store computer-executable instructions and a processor in communication with the data store, wherein the computer-executable instructions, when executed by the processor, configure the processor to perform operations including obtaining an event schedule including a plurality of events, each even comprising a scheduled start time and duration; determining that a current time corresponds to the scheduled start time of a first event; determining that the first event corresponds to a conference for which a virtual assistant has been requested; establishing an audio connection to the conference; receiving audio data via the audio connection; determining associations between portions of the audio data and individual participants in the conference based at least in part on a machine learning model trained on previously obtained audio data; generating a transcript based at least in part on the audio data and the associations; and updating the first event on the event schedule to include information regarding the transcript.

In some embodiments, the operations further include transmitting an audio message indicating that the conference is being recorded; and receiving from individual participants an indication that the individual consents to being recorded.

In some embodiments, the transcript includes only portions of the audio data associated with participants to consent to being recorded.

In some embodiments, the operations further include determining, based at least in part on the audio data and the machine learning model, an actual start time or actual end time of the conference.

In some embodiments, the operations further include generating a summary of the transcript based at least in part on natural language processing of the audio data. In further embodiments, updating the first event to include information regarding the transcript comprises updating the event to include the summary.

In various embodiments, a computer-implemented method is disclosed comprising determining that a current time corresponds to a start time of an event on an electronic calendar; establishing an audio connection to the event; receiving audio data associated with the event; determining associations between portions of the audio data and individual participants in the event based at least in part on a machine learning model trained on previously obtained audio data; generating, based at least in part on the audio data and the associations, a transcript of the event identifying the participants and associated portions of the audio data; and associating the transcript with the event on the electronic calendar.

In some embodiments, the computer-implemented method further comprises determining that one of the event participants is a key participant. In further embodiments, the computer-implemented method further comprises determining that a likelihood of the key participant attending the event does not satisfy a threshold; in response, generating a reminder to attend the event; and transmitting the reminder to the key participant. In still further embodiments, generating the reminder comprises identifying a topic of interest to the key participant, and the reminder indicates that the vent is associated with the topic of interest.

In some embodiments, the computer-implemented method further comprises determining, based on the audio data, that a quorum is present at the event.

In some embodiments, establishing an audio connection to the event comprises establishing a connection to one or more of a teleconference, videoconference, or chat room.

In some embodiments, the transcript comprises timestamped portions of the audio data, and individual timestamped portions are associated with respective participants.

In some embodiments, the machine learning model is trained on previously obtained audio data associated with at least some of the participants.

In some embodiments, the computer-implemented method further comprises determining, based on the audio data, that the event has ended; and terminating the connection to the event.

In some embodiments, the computer-implemented method further comprises determining, during the event, that a portion of the audio data corresponds to a query addressed to a virtual assistant; extracting the query from the audio data; processing the query to obtain search results; and transmitting at least a portion of the search results via the audio connection.

In various embodiments, a non-transitory computer-readable medium is disclosed having computer-executable instructions that, when executed by a processor, configure the processor to perform operations including receiving audio data associated with an event on an electronic calendar; determining, based at least in part on a machine learning model trained on previously obtained audio data, associations between portions of the audio data and individual participants in the event; generating, based at least in part on the audio data and the associations, a transcript of the event including information identifying the participants and associated portions of the audio data; and associating the transcript with the event on the electronic calendar.

In some embodiments, associating the transcript with the event on the electronic calendar comprises associating an electronic file comprising the transcript with the event.

In some embodiments, the operations further include establishing the audio connection at a scheduled start time of the event.

In some embodiments, the event comprises one or more of an audio conference, video conference, or web conference.

### BRIEF DESCRIPTION OF THE DRAWINGS

Embodiments of various inventive features will now be described with reference to the following drawings. Throughout the drawings, the examples shown may re-use reference numbers to indicate correspondence between referenced elements. The drawings are provided to illustrate example embodiments described herein and are not intended to limit the scope of the disclosure.

FIG. 1 is a pictorial diagram depicting an illustrative environment for coordinated intelligent multi-party conferencing.

FIG. 2 is a block diagram depicting an illustrative computing device that can implement the calendar assistant server shown in FIG. 1.

FIG. 3 is a process flow diagram for an example method of scheduling a multi-party conference.

FIG. 4 is a process flow diagram illustrating an example method of intelligent confirmation of a multi-party conference.

FIG. 5 is a process flow diagram illustrating an example method of assisted multi-party conferencing.

### DETAILED DESCRIPTION

Generally described, aspects of the present disclosure relate to multi-party conferencing. More specifically, aspects of the present disclosure are directed to systems, methods, and computer-readable media for facilitating multi-party conferencing. Features are included to call into scheduled conferences automatically or selectively based on, for example, user profile or system resource availability levels. The system may, in some embodiments, use machine learning to determine how to join a scheduled conference. For example, if the conference is a telephone conference, the system may make an audio connection to the conference using a mobile computing device or other telecommunications device. If the conference is a multi-feature conference such as a Zoom™, WebEx™, etc., the system may establish an online connection. The system may then, in some embodiments, automatically record all or part of the conference and generate a transcript of conversations that took place during the conference. The system may associate the transcript with the calendar event for the conference. For example, the system may attach the transcript to an invitation or calendar event for the conference. If calling in via Zoom or similar conferencing technology, the system may obtain information to distinguish each participant uniquely and may identify the participants in the conversation. If not, the system may use machine learning or other techniques, as described in more detail below, to identify each person involved.

In some embodiments, the system may, through machine learning, analyze the conference and summarize points that were important during that meeting. Important points may be identified based on factors such as the person speaking, the speaker's tone, volume, animation or emotion, rate of speech, or other characteristics. The main points of the conversation may be put back into the calendar invite and highlighted and/or indexed for identification in the future. This helps a user or a system to quickly identify what happened during an event without having to read the whole transcript. It also helps identify a conversation using the main points rather than having to dig into the details.

Additional features are described for ensuring that key participants are attending conferences. When a user sends a calendar invite to multiple people, the request can identify who in the invite is a key participant (for example, in a sales conference, who is the true decision maker). A conference may have key participants. These are people that are required to attend the conference or the system will automatically reschedule the conference. An organizer can select a time limit before the meeting where if the key participant(s) do not respond, the system will automatically reschedule the meeting to a time that works for the key participant(s). The system may also analyze the key participant(s)' prior attendance to determine a likelihood that the key participant(s) will attend the conference. If they cannot, or if the likelihood is below a threshold, the system may automatically reschedule the meeting to a time when the key participant(s) can attend.

The foregoing aspects and many of the attendant advantages will become more readily appreciated as the same become better understood by reference to the following descriptions of illustrative embodiments, when taken in conjunction with the accompanying drawings depicting the illustrative embodiments.

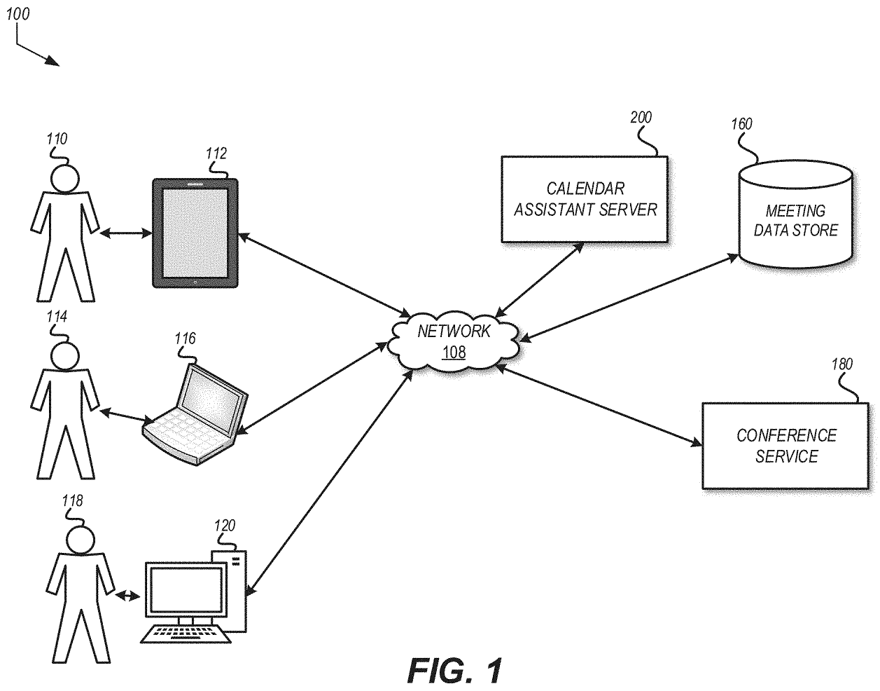

FIG. 1 is a pictorial diagram depicting an illustrative environment for coordinated intelligent multi-party conferencing. The environment 100 includes three users (for example, user 110, user 114, and user 118). A user may be associated with one or more access device. As shown in FIG. 1, the user 110 is associated with access device 112. The user 114 is associated with access device 116 and the user 118 is associated with access device 120. The association may be with the access device or an application executing thereon such a conferencing or scheduling application. The conferencing or scheduling application may include a graphical user interface for presenting and receiving information related to scheduled conferences. The conferences may include teleconferences, video conferences, screen sharing conferences, or other multi-party communication sessions. A conference may be scheduled for a specific time or place. A conference may be scheduled to use one or more resources such as a physical room, a video conference room, a telephone extension, or other physical or virtual resources. The conference may have an organizer who indicates the need for the meeting and one or more participants who are invited by the organizer to join the conference.

A calendar assistant server 200 may be included in the environment to provide at least some of the coordinated intelligent multi-party conferencing features described. The calendar assistant server 200 may be accessed by an access device via a network 108. The network 108 may provide equipment for establishing connections via one or more of a public switched telephone network (PSTN), wired data connection, wireless internet connection (for example, LTE, Wi-Fi, etc.), local area network (LAN), a wide area network, plain old telephone service (POTS), telephone exchanges, or the like. Messages may be transmitted using standardized protocols such as TCP/IP or proprietary protocols. The messages may include scheduling requests to establish a conference. In some implementations, third-party calendar services may be hosted at an address of the network 108. For example, GOOGLE and MICROSOFT offer calendaring applications. The calendaring applications may be accessed using iCalendar, vCalendar, RSS, OPML, or other calendar exchange protocols. In some implementations, the calendaring application may require authorization information to access a user's calendar. The authorization information may include a username, password, authority token, key, or other credential. The user 110 may create a profile with the calendar assistant server 200 to link with such third-party calendaring applications. The calendar assistant server 200 may then aggregate the specified calendars to provide a single view for the user 110.

The profile may allow the user 110 to specify the visibility of each calendar or for specific events shared through the calendar assistant server 200. In this way, the user 110 may allow a work calendar to co-exist with a personal calendar and a shared calendar such as a bowling league schedule. The user 110 may hide the details of their personal calendar and specify events from the bowling league schedule appear to other users as “exercise time.” The privacy setting may be user specific. For example, the user 110 may want all details to be viewable by a spouse, but more vague descriptions (if any) shown to a direct report from work.

A meeting data store 160 may be included in the environment 100. The meeting data store 160 may store information about conferences scheduled through the calendar assistant server 200 such as time, date, place, resources, attendee responses (for example, accept, decline, tentative), actual conference attendance, or the like. The meeting data store 160 may store user profile information including third-party calendars integration information. The meeting data store 160 may store recordings or other information generated during the conference such as files presented, chats, audio, or the like. In some embodiments, the meeting data store 160 may communicate directly with the conference service 180 and/or the calendar assistant server 200 rather than communicating via the network 108. In further embodiments, the meeting data store 160 may be implemented as a component of the conference service 180 or the calendar assistant server 200.

As used herein, a “data store” may be embodied in hard disk drives, solid state memories and/or any other type of non-transitory computer-readable storage medium accessible to or by a device such as an access device, server, or other computing device described. A data store may also or alternatively be distributed or partitioned across multiple local and/or remote storage devices as is known in the art without departing from the scope of the present disclosure. In yet other embodiments, a data store may include or be embodied in a data storage web service.

A conference may be conducted using a conferencing service 180. Examples of a conferencing service 180 include WEBEX, GOOGLE Hangouts, a telephonic voice conference room system, or the like. The conferencing service 180 may be accessed by the calendar assistant server 200 and access devices via the network 108.

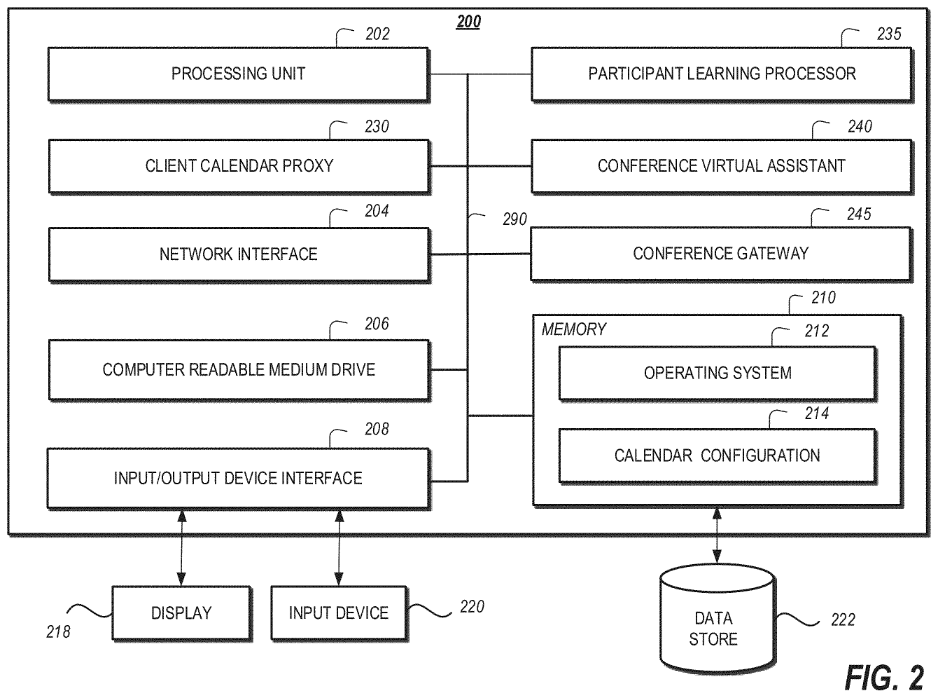

FIG. 2 is a block diagram depicting an illustrative computing device that can implement the calendar assistant server shown in FIG. 1. The calendar assistant server 200 can be a server or other computing device, and can comprise a processing unit 202, a network interface 204, a computer readable medium drive 206, an input/output device interface 208, a memory 210 a client calendar proxy 230, a participant learning processor 235, a conference virtual assistant 240, and a conference gateway 245. The network interface 204 can provide connectivity to one or more networks or computing systems. The processing unit 202 can receive information and instructions from other computing systems or services via the network interface 204. The network interface 204 can also store data directly to memory 210 or other data store. The processing unit 202 can communicate to and from memory 210 and output information to an optional display 218 via the input/output device interface 208. The input/output device interface 208 can also accept input from the optional input device 220, such as a keyboard, mouse, digital pen, microphone, mass storage device, etc.

The client calendar proxy 230 may provide interchange functionality to communicate with a third-party calendaring service. For example, a user profile may include information to access the user's calendar from a third-party service. The client calendar proxy 230 may ingest information from or publish information to the third-party service via the client calendar proxy 230. The client calendar proxy 230 may be dynamically configured based on the third-party service and/or user. For example, a specific service may desire updates on a scheduled basis (for example, no less than every 15 minutes). The client calendar proxy 230 may coordinate conferences for a user managed by the third-party service, the calendar assistant server 200, or other third-party service associated with the user's profile. This coordination may be referred to as synchronizing calendars across platforms and services.

The participant learning processor 235 may include artificial intelligence or other machine learning components to model users of the calendar assistant server 200. For example, the historic attendance of a user to meetings or the likelihood of user to attend a meeting they've accepted may be determined using prior attendance information accessible by the participant learning processor 235. The participant learning processor 235 may generate models of specific users or categories of similar users (for example, users within the same organization or having similar titles (for example, sales representative)).

The conference virtual assistant 240 may be an automated agent that can attend conferences. The conference virtual assistant 240 may be a passive attendee. As a passive attendee, the conference virtual assistant 240 may call a conference, record the proceedings of the conference, and collect any files exchanged during the conference. The conference virtual assistant 240 may process the recorded or collected materials from the conference and transmit the processing results to the meeting attendees. For example, if the conference was an audio conference, the conference virtual assistant 240 may dial into the conference and record the conversation. After the conversation is completed, the conference virtual assistant 240 may generate a transcription of the audio recording. The conference virtual assistant 240 may be configured to transmit the transcription to all or specified meeting participants.

In some implementations, the conference virtual assistant 240 may be an active attendee. In active mode, the conference virtual assistant 240 may respond to inquiries during the conference. For example, an attendee may have a question about specific information such as “What were the total sales for last quarter?” The conference virtual assistant 240 may determine the question was asked and transmit the audio of the utterance to a voice recognition service to obtain the requested information. In some implementations, the voice recognition service may be implemented within the calendar assistant server 200. In some implementations, the voice recognition service may be hosted remotely such as by a device associated with the organizer of the conference. In such implementations, the conference virtual assistant 240 may transmit the utterance to a network service and receive a response to present. The conference virtual assistant 240 may determine that an utterance is directed to it through the use of a wake word or other predetermined key phrase allocated to the conference virtual assistant 240. The wake word may be specified in a configuration accessible by the conference virtual assistant 240.

To connect to a conference, the conference virtual assistant 240 may access the conference gateway 245. The conference gateway 245 provides a communication path from the calendar assistant server 200 to one or more conferencing services. In some implementations, the conference gateway 245 may translate between communication technologies (for example, VoIP to analog audio for transmission via a PSTN). For video conferences, the conference gateway 245 may generate a video stream to represent the conference virtual assistant 240. The video stream may include an avatar or other visual representation of the conference virtual assistant 240. The representation may be a static image or an animated image that is coordinated to provide human-like responses to the meeting. For example, if laughter is detected during the conference, the conference virtual assistant 240 may be animated from a straight face to a smile.

The memory 210 contains specific computer program instructions that the processing unit 202 or other element of the calendar assistant server 200 may execute to implement one or more embodiments. The memory 210 may include RAM, ROM, and/or other persistent, non-transitory computer readable media. The memory 210 can store an operating system 212 that provides computer program instructions for use by the processing unit 202 or other elements included in the computing device in the general administration and operation of the calendar assistant server 200. The memory 210 can further include computer program instructions and other information for implementing aspects of the present disclosure.

For example, in one embodiment, the memory 210 includes a calendar configuration 214. The calendar configuration 214 may include the thresholds (for example, attendance likelihood metric, key participant identification metric, etc.), transcription service(s) or information to access a transcription service, conference resource service(s), and other configurable parameters to dynamically adjust the calendar assistant server 200 to schedule conferences, assess the need for rescheduling a conference, and providing virtual assistance for a conference. The calendar configuration 214 may store specific values for a given configuration element. For example, the specific threshold value may be included in the calendar configuration 214. The calendar configuration 214 may, in some implementations, store information for obtaining specific values for a given configuration element such as from a network location (for example, URL).

The memory 210 may also include or communicate with one or more auxiliary data stores, such as data store 222. The data store 222 may electronically store data regarding a conference, content exchanged during a conference, transcripts of a conference, transcription information, and the like.

The elements included in the calendar assistant server 200 may be coupled by a bus 290. The bus 290 may be a data bus, communication bus, or other bus mechanism to enable the various components of the calendar assistant server 200 to exchange information.

In some embodiments, the calendar assistant server 200 may include additional or fewer components than are shown in FIG. 2. For example, a calendar assistant server 200 may include more than one processing unit 202 and computer readable medium drive 206. In another example, the calendar assistant server 200 may not be coupled to a display 218 or an input device 220. In some embodiments, two or more computing devices may together form a computer system for executing features of the present disclosure.

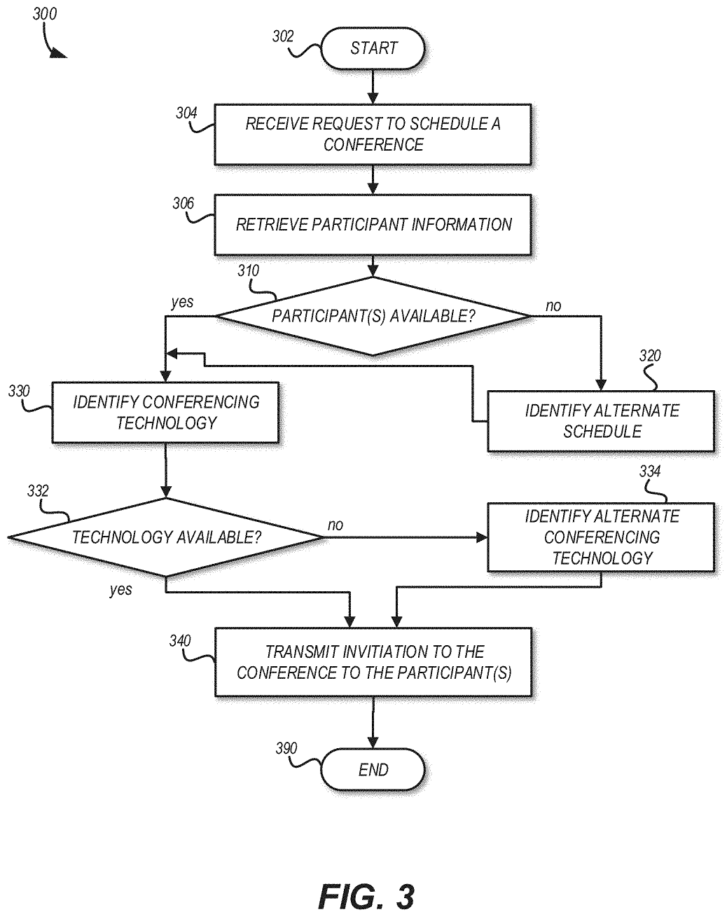

FIG. 3 is a process flow diagram for an example routine for scheduling a multi-party conference. The routine 300 may be implemented in whole or in part by the devices shown in FIG. 1. In some implementations, the routine 300 may be coordinated by a coordination device such as the calendar assistant server 200.

The routine 300 begins at block 302. At block 304, the coordination device may receive a request to schedule a conference. The request may include time information indicating when the conference should begin. In some implementations, the request may include the name of participants. If no time information is included, the coordination device may identify a time that the identified participants are available and/or likely to attend. The request may include information identifying one or more resource for the conference such as a physical resource (for example, room, equipment, etc.), virtual resource (for example, teleconference number, video conference room information), or the like.

At block 306, the coordination device may retrieve participant information. The retrieval may include collecting participant schedule information from a third party scheduling service. The retrieval may include identifying historic schedule and attendance information for a participant.

At block 310, the coordination device may determine whether the identified participants are available for the identified time of the conference. The availability may be based on the participant information obtained at block 306.

If the determination at block 310 is negative, the coordination device may, at block 320, identify an alternative schedule for the conference. The alternative schedule may be selected based on the participant information and, in some instances, a metric indicating the likelihood that a participant may attend at a given time. Once an alternate schedule is identified, or if the determination at block 310 is affirmative, the coordination device may, at block 330, identify a conferencing technology to use for the conference. In some embodiments, the routine 300 may return to block 310 after identifying an alternate schedule, and may determine whether participants are available at the time indicated in the alternative schedule. If not, then the routine 300 may further iterate and test other alternate schedules, or may select a schedule from among the alternatives based on various criteria, such as maximizing the number of attendees or ensuring that key attendees can attend.

Not all participants may have access to the same conferencing technology. In some instances, a participant's network may prohibit the use certain networked conferencing technologies. In some instances, a participant may have a disability that makes certain conferencing technologies more accessible than others. At block 330, the coordination device may identify a common conferencing technology that can be accessed by the identified participants. If there are multiple technologies available, the coordination device may select a technology based on the participants. For example, if the participants can all use technology “A” and technology “B” but a key participant in the conference shows a preference for technology “B” based on historic conference information, the coordination device may select technology “B”.

At block 332, the coordination device may determine whether the conferencing technology identified at block 330 is available for the scheduled conference. If the determination at block 332 is negative, the routine 300 may proceed to block 334 to identify an alternate technology. The identification may be similar to the identification at block 330 with the added constraint of the time information. In some embodiments, the coordination device may determine at block 334 whether an alternate conferencing technology is available, and if not the routine 300 may terminate after optionally indicating that the conference could not be scheduled.

If the determination at block 332 is affirmative or once an alternate conferencing technology is identified at block 334, the coordination device may, at block 340, transmit an invitation to the conference participant(s). The transmission may include adding entries to one or more calendars or third-party calendars. The transmission may include reserving the conferencing technology or other resource for the conference.

The routine 300 may end at block 390, but can be repeated to schedule additional conferences.

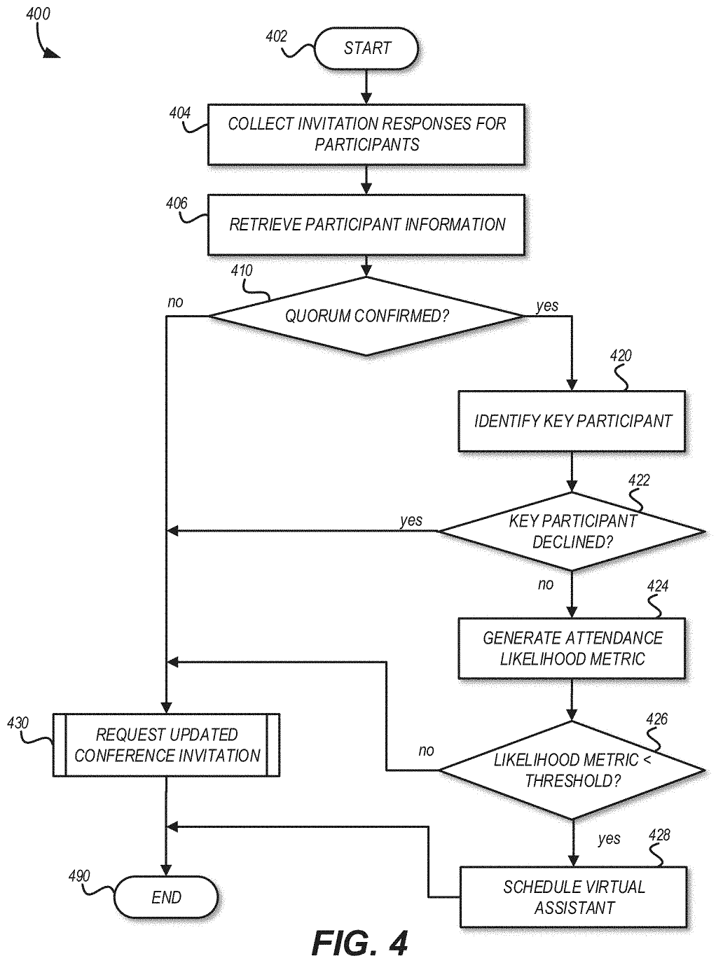

FIG. 4 is a process flow diagram illustrating an example method of intelligent confirmation of a multi-party conference. The routine 400 may be implemented in whole or in part by the devices shown in FIG. 1. In some implementations, the routine 400 may be coordinated by a coordination device such as the calendar assistant server 200.

The routine 400 begins at block 402. At block 404, the coordination device may collect invitation responses for the participants in the conference. The collection may include retrieving calendar information from third-party calendaring services for the participants. At block 406, the coordination device may retrieve participant information. The retrieval may include collecting participant schedule information from a third party scheduling service. The retrieval may include identifying historic schedule and attendance information for a participant.

At block 410 the coordination device may determine whether a quorum of participants have confirmed attendance for the conference. A quorum generally refers to a minimum number of participants needed for a conference. In some implementations, the quorum may be specified as a number of participants (for example, 2 or more). In some implementations, the quorum may be specified as a percent of invitees (for example, 51% or more). The quorum may be specified when the conference is requested (for example, by the organizer). In some implementations, the quorum may be specified as a default for the calendar assistant server.

If the quorum is not confirmed, the coordination device may, at block 430, request transmission of an updated conference invitation. The request may be submitted and processed using the routine 300 shown in FIG. 3. The routine 400 may then end at block 490.

If the quorum is confirmed, it may be desirable to confirm specific participants attend the conference. For example, if an elementary school classroom conference is being scheduled, a quorum may be met if all the parents confirm attendance, but if the teacher of the classroom (for example, a key participant) has not accepted, the conference may not meet its objective. Accordingly, the coordination device may, at block 420, identify a key participant. The identification of a key participant may be based on the original request in which the organizer may tag or otherwise identify key participants. The model may analyze behavior patterns, interest levels, or other characteristics of a participant to generate a likelihood of attendance. For example, a model may identify that a participant is more likely to attend a meeting if a reminder text message is sent ten minutes before the meeting, and may factor this into account (and may schedule sending the reminder) when determining the likelihood of attendance. In some embodiments, the time and type of reminder may be determined based on dynamic factors such as the person's location and activities. For example, a text message may be sent if the person is on the phone when a reminder is due, or the time of the reminder may be scheduled based on how long it typically takes the person to travel to the meeting. As a further example of behavior patterns, the model may identify a topic of interest to the participant, and may determine that the participant is more likely to attend meetings regarding that topic. The model may identify topics of interest based on data such as the person's participation at previous meetings, tone of voice, calendar events, search history, or other information.

At block 426, the coordination device may determine whether the likelihood of attendance is below a target threshold. The target threshold may be specified by the organizer submitting the original conference request. The target threshold may be specified as a system default or a default for users associate with a particular account or profile. In some implementations, the likelihood metric may be assessed for correspondence with the target threshold. As used herein, the term “correspond” encompasses a range of relative relationships between two or more elements. Correspond may refer to equality (for example, match). Correspond may refer to partial-equality (for example, partial match, fuzzy match, soundex). Correspond may refer to a value which falls within a range of values.

If the determination at block 426 is negative, the routine 400 may proceed to block 300 as described above. If the determination at block 426 is affirmative, at block 428, the coordination device may schedule a virtual assistant to attend the conference. Because the virtual assistant may utilize limited computing resources, it may be desirable to defer the scheduling and/or instantiation of the virtual assistant until the conference and likelihood of attendance of at least key attendees have been confirmed. The routine 400 may then end at block 490 but can be repeated to assess confirmations for the same or other conferences.

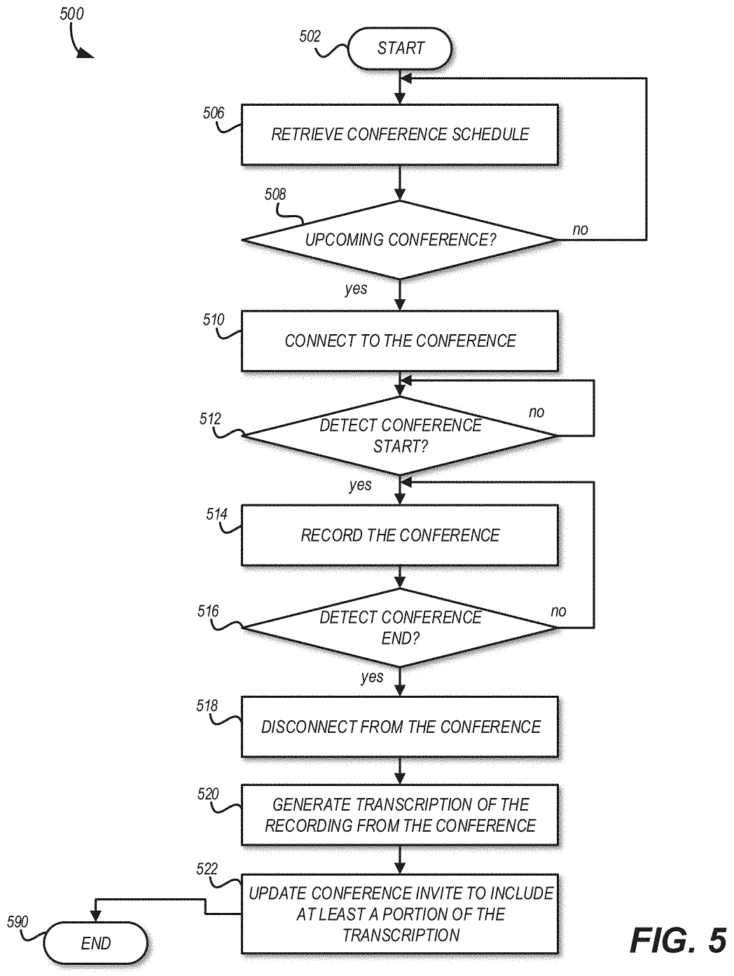

FIG. 5 is a process flow diagram illustrating an example routine of assisted multi-party conferencing. The routine 500 may be implemented in whole or in part by the devices shown in FIG. 1. In some implementations, the routine 500 may be coordinated by a coordination device such as the calendar assistant server 200.

The routine 500 begins at block 502. At block 506, the coordination device may retrieve the conference schedule. The conference schedule may identify time information for a conference for which a virtual assistant has been requested such as via the routine 400 shown in FIG. 4. At block 508, the coordination device may determine whether a conference is upcoming. An upcoming conference may be assessed based on a current time and the time associated with a scheduled conference. The coordination device may determine whether the current time corresponds to the time associated with a scheduled conference. The correspondence may be dynamically assessed such as based on conferencing technology. For example, it may take several minutes for a virtual assistant to call or connect to a specific conferencing technology.

If the coordination device determines, at block 508, that a conference is upcoming, the coordination device may, at block 510 connect to the conference. Connecting to the conference may include initiating a call, such as via the conference gateway. The connecting may be based on information included in the invitation for the conference. The information may include conference identifier or conference password information to present to gain access to the conference. In some implementations, the coordination device may set up or assist in setting up the conference. For example, the virtual assistant may open a teleconference bridge, establish a videoconference link, create a chat room, or otherwise facilitate use of a conferencing technology. Additionally, in some implementations, the coordination device may make multiple attempts to connect to a conference, or may attempt to connect via a different technology if unable to do so via a first technology. For example, the coordination device may fall back to an audio-only connection if unable to establish a video connection, or may attempt an Internet-based audio connection and then try again using a telephony-based connection.

At block 512, the coordination device may determine whether the conference start is detected. The detection may be based on audio or video information transmitted via the call. For example, a conference call service may transmit a specific tone to indicate the beginning of a conference. The specific tone may be identified prior to connecting to the conference.

If the determination at block 512 is negative, the routine 500 may continue waiting by returning to block 512. In some implementations, the detection may include a delay between successive determinations, and may ultimately time out if it appears that the conference is not going to start. If the determination at block 512 is affirmative, at block 514, the coordination device may record the conference. Recording the conference may include recording audio, video, or textual information communicated during the conference. In some implementations, the recording may include presenting information to the conference or participants that the conference is being recorded. In some implementations, the recording may be predicated on receiving an acknowledgment signal from the participants (for example, please press 1 if you consent to recording this conference).

In some embodiments, the coordination device may record each participant in the conference separately in order to facilitate identifying and differentiating between individual speakers. The coordination device may, for example, record and timestamp audio from each participant, and may generate a transcription of the conference based on the separate audio recordings.

At block 516, the coordination device may detect the end of the conference. In some implementations, the end may be detected based on the call status (for example, if the call is disconnected). In some implementations, the end may be detected based on audio or video information transmitted via the call such as a “goodbye” message.

If the end of the conference is not detected, the routine 500 may return to 514 to continue recording the conference. If the end of the conference is detected at block 516, the coordination device may disconnect from the conference 518. Disconnection may include closing a communication channel with the conferencing technology. When a specific gateway is created for the conference, the disconnection may include tearing down the gateway instance to free the processing or calling resources for other conferences.

At block 520, the coordination device may generate a transcription of the recording from the conference. The transcription may be generated by providing all or portions of the audio data to a transcription service and receiving a text document of the utterances. When available, audio data may be associated with specific participants. In such instances, information identifying the participant who spoke an utterance may be included in the transcript. If not available, the system may use machine learning to identify speakers. For example, the participant learning may compare an utterance with utterances previously attributed to a participant. The system may then determine that the utterance corresponds to the previous utterance thereby identifying the speaker. In some implementations, the transcription may include summarizing the conference. The summary may be generated through theme extraction or other natural language processing of the conference audio data. The coordination device may store the items generated at block 520 in a meeting data store.

At block 522, the coordination device may update a conference invitation to include at least a portion of the transcription or other information generated at block 520. The update may include adding a file attachment to the invitation or adding a link to a network location for retrieving one or more files for the conference. The updating may include updating calendars managed by the calendar assistant server or a third-party calendaring service. The routine 500 may end at block 590 but can be repeated for additional conferences.

In some embodiments, the coordination device may generate a transcript or otherwise process audio data in real time or near real time. For example the coordination device may generate and display real-time information regarding meeting participants, such as who is currently speaking, the total length of time that each participant has spoken, and so forth. In other embodiments, the coordination device may post-process audio data or other conference data to generate a transcript after the meeting has completed. Conference recordings, transcripts, and other data may be stored in an encrypted format and may be segregated across multiple storage devices for security. In some embodiments, the coordination device may provide application programming interfaces (“APIs”), integrations with customer relationship management (“CRM”) platforms, or other interfaces to facilitate access to conference data.

Depending on the embodiment, certain acts, events, or functions of any of the processes or algorithms described herein can be performed in a different sequence, can be added, merged, or left out altogether (for example, not all described operations or events are necessary for the practice of the algorithm). Moreover, in certain embodiments, operations, or events can be performed concurrently, for example, through multi-threaded processing, interrupt processing, or multiple processors or processor cores or on other parallel architectures, rather than sequentially.

The various illustrative logical blocks, modules, routines, and algorithm steps described in connection with the embodiments disclosed herein can be implemented as electronic hardware, or as a combination of electronic hardware and executable software. To clearly illustrate this interchangeability, various illustrative components, blocks, modules, and steps have been described above generally in terms of their functionality. Whether such functionality is implemented as specialized hardware, or as specific software instructions executable by one or more hardware devices, depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A coordination device can be or include a microprocessor, but in the alternative, the coordination device can be or include a controller, microcontroller, or state machine, combinations of the same, or the like configured to coordinate multi-party conferences. A coordination device can include electrical circuitry configured to process computer-executable instructions. Although described herein primarily with respect to digital technology, a coordination device may also include primarily analog components. For example, some or all of the transcription algorithms or interfaces described herein may be implemented in analog circuitry or mixed analog and digital circuitry. A computing environment can include a specialized computer system based on a microprocessor, a mainframe computer, a digital signal processor, a portable computing device, a device controller, or a computational engine within an appliance, to name a few.

The elements of a method, process, routine, interface, or algorithm described in connection with the embodiments disclosed herein can be embodied directly in specifically tailored hardware, in a specialized software module executed by a coordination device, or in a combination of the two. A software module can reside in random access memory (RAM) memory, flash memory, read only memory (ROM), erasable programmable read-only memory (EPROM), electrically erasable programmable read-only memory (EEPROM), registers, hard disk, a removable disk, a compact disc read-only memory (CD-ROM), or other form of a non-transitory computer-readable storage medium. An illustrative storage medium can be coupled to the coordination device such that the coordination device can read information from, and write information to, the storage medium. In the alternative, the storage medium can be integral to the coordination device. The coordination device and the storage medium can reside in an application specific integrated circuit (ASIC). The ASIC can reside in an access device or other coordination device. In the alternative, the coordination device and the storage medium can reside as discrete components in an access device or electronic communication device. In some implementations, the method may be a computer-implemented method performed under the control of a computing device, such as an access device or electronic communication device, executing specific computer-executable instructions.

Conditional language used herein, such as, among others, “can,” “could,” “might,” “may,” “e.g.,” “for example,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each is present.

Unless otherwise explicitly stated, articles such as “a” or “a” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

As used herein, the terms “determine” or “determining” encompass a wide variety of actions. For example, “determining” may include calculating, computing, processing, deriving, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing, and the like.

As used herein, the term “selectively” or “selective” may encompass a wide variety of actions. For example, a “selective” process may include determining one option from multiple options. A “selective” process may include one or more of: dynamically determined inputs, preconfigured inputs, or user-initiated inputs for making the determination. In some implementations, an n-input switch may be included to provide selective functionality where n is the number of inputs used to make the selection.

As used herein, the terms “provide” or “providing” encompass a wide variety of actions. For example, “providing” may include storing a value in a location for subsequent retrieval, transmitting a value directly to the recipient, transmitting or storing a reference to a value, and the like. “Providing” may also include encoding, decoding, encrypting, decrypting, validating, verifying, and the like.

As used herein, the term “message” encompasses a wide variety of formats for communicating (e.g., transmitting or receiving) information. A message may include a machine readable aggregation of information such as an XML document, fixed field message, comma separated message, or the like. A message may, in some implementations, include a signal utilized to transmit one or more representations of the information. While recited in the singular, it will be understood that a message may be composed, transmitted, stored, received, etc. in multiple parts.

As used herein, a “user interface” (also referred to as an interactive user interface, a graphical user interface, an interface, or a UI) may refer to a network based interface including data fields and/or other controls for receiving input signals or providing electronic information and/or for providing information to the user in response to any received input signals. A UI may be implemented in whole or in part using technologies such as hyper-text mark-up language (HTML), ADOBE® FLASH®, JAVA®, MICROSOFT® .NET®, web services, and rich site summary (RSS). In some implementations, a UI may be included in a stand-alone client (for example, thick client, fat client) configured to communicate (e.g., send or receive data) in accordance with one or more of the aspects described.

As used herein, a “call” may encompass a wide variety of communication connections between at least a first party and a second party. A call may additionally encompass a communication link created by a first party that has not yet been connected to any second party. A call may be a communication link between any combination of a communication device (e.g., a telephone, smartphone, hand held computer, etc.), a VoIP provider, other data server, a call center including any automated call handling components thereof, or the like. A call may include connections via one or more of a public switched telephone network (PSTN), wired data connection, wireless internet connection (e.g., LTE, Wi-Fi, etc.), local area network (LAN), plain old telephone service (POTS), telephone exchanges, or the like. A call may include transmission of audio data and/or non-audio data, such as a text or other data representation of an audio input (e.g., a transcript of received audio). Accordingly, a connection type for a call may be selected according to the type of data to be transmitted in the call. For example, a PSTN or VoIP connection may be used for a call in which audio data is to be transmitted, while a data connection may be used for a call in which a transcript or other non-audio data will be transmitted.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes that come within the meaning and range of equivalency of the claims are to be embraced within their scope.

What is claimed is:

1. A system, comprising:
a data store configured to store computer-executable instructions; and
a processor in communication with the data store, wherein the computer-executable instructions, when executed by the processor, configure the processor to perform operations including:
obtaining an event schedule, the event schedule including a plurality of events, each of the plurality of events comprising a scheduled start time and a scheduled duration;
determining that a current time corresponds to the scheduled start time of a first event of the plurality of events;
determining that the first event corresponds to a conference for which a virtual assistant has been requested, the conference comprising a plurality of participants;
establishing at least an audio connection to the conference;
receiving, via the audio connection, audio data associated with the conference;
determining one or more associations between portions of the audio data and individual participants of the plurality of participants based at least in part on a machine learning model trained on previously obtained audio data;
generating, based at least in part on the audio data and the one or more associations, a transcript of the conference, the transcript including information regarding the one or more associations; and
updating the first event on the event schedule to include information regarding the transcript.

2. The system of claim 1, wherein the operations further include:
transmitting an audio message via the audio connection, the audio message indicating that the conference is being recorded; and
receiving, from individual participants of the plurality of participants, an indication that the individual participant consents to being recorded.

3. The system of claim 2, wherein the transcript includes only portions of the audio data associated with participants who consent to being recorded.

4. The system of claim 1, wherein the operations further include determining, based at least in part on the audio data and the machine learning model, at least one of an actual start time of the conference or an actual end time of the conference.

5. The system of claim 1, wherein the operations further include generating a summary of the transcript based at least in part on natural language processing of the audio data.

6. The system of claim 5, wherein updating the first event to include information regarding the transcript comprises updating the first event to include the summary.

7. A computer-implemented method, comprising:
determining that a current time corresponds to a start time of an event on an electronic calendar, wherein the event is associated with a plurality of participants;
establishing at least an audio connection to the event;
receiving, via the audio connection, audio data associated with the event;
determining one or more associations between portions of the audio data and individual participants of the plurality of participants based at least in part on a machine learning model trained on previously obtained audio data;
generating, based at least in part on the audio data and the one or more associations, a transcript of the event, the transcript including information identifying the individual participants and the associated portions of the audio data; and
associating the transcript with the event on the electronic calendar.

8. The computer-implemented method of claim 7 further comprising determining that one of the participants in the event is a key participant.

9. The computer-implemented method of claim 8 further comprising:
determining that a likelihood that the key participant will attend the event does not satisfy a threshold;
in response to determining that the likelihood does not satisfy the threshold, generating a reminder to attend the event; and
transmitting the reminder to the key participant.

10. The computer-implemented method of claim 9, wherein generating the reminder comprises identifying a topic of interest to the key participant, and wherein the reminder indicates that the event is associated with the topic of interest.

11. The computer-implemented method of claim 7 further comprising determining, based at least in part on the audio data, that a quorum is present at the event.

12. The computer-implemented method of claim 7, wherein establishing at least an audio connection to the event comprises establishing a connection to one or more of a teleconference, videoconference, or chat room.

13. The computer-implemented method of claim 7, wherein the transcript comprises a plurality of timestamped portions of the audio data, and wherein individual timestamped portions of the plurality of timestamped portions are associated with respective participants.

14. The computer-implemented method of claim 7, wherein the machine learning model is trained on previously obtained audio data associated with at least a portion of the plurality of participants.

15. The computer-implemented method of claim 7 further comprising:
determining, based at least in part on the audio data, that the event has ended; and
terminating the audio connection to the event.

16. The computer-implemented method of claim 7 further comprising:
determining, during the event, that a portion of the audio data corresponds to a query addressed to a virtual assistant;
extracting the query from the portion of the audio data;
processing the query to obtain search results; and
transmitting at least a portion of the search results via the audio connection.

17. A non-transitory computer-readable medium storing computer-executable instructions that, when executed by a processor, configure the processor to perform operations including:
receiving, via an audio connection, audio data associated with an event on an electronic calendar;
determining, based at least in part on a machine learning model trained on previously obtained audio data, one or more associations between portions of the audio data and individual participants in the event;
generating, based at least in part on the audio data and the one or more associations, a transcript of the event including information identifying the individual participants and the associated portions of the audio data; and
associating the transcript with the event on the electronic calendar.

18. The non-transitory computer-readable medium of claim 17, wherein associating the transcript with the event on the electronic calendar comprises associating an electronic file comprising the transcript with the event.

19. The non-transitory computer-readable medium of claim 17, wherein the operations further include establishing the audio connection at a scheduled start time of the event.

20. The non-transitory computer-readable medium of claim 17, wherein the event comprises one or more of an audio conference, video conference, or web conference.
